(19) United States
(12) Patent Application Publication
(10) Pub. No.: US 2019/0026006 A1
(43) Pub. Date: Jan. 24, 2019

(54) SYSTEM AND METHOD FOR PRESENTING VIDEO AND ASSOCIATED DOCUMENTS AND FOR TRACKING VIEWING THEREOF

(71) Applicant: IMPRESSVIEW INC, Montreal (CA)

(72) Inventor: Imad Ezzeddine, Montreal (CA)

(21) Appl. No.: 16/066,968

(22) PCT Filed: Dec. 23, 2016
(86) PCT No.: PCT/CA2016/051534

§ 371 Date: Jun. 28, 2018

Related U.S. Application Data
(60) Provisional application No. 62/272,089, filed on Dec. 29, 2015.

(51) Int. Cl. G06F 3/0481; G06F 17/30; G06F 3/0482; G11B 27/36; G11B 27/036

(52) U.S. Cl. CPC G06F 3/04815; G06F 17/30846; G11B 27/036; G11B 27/36; G06F 3/0482

(57) ABSTRACT

A system and method for presenting information associated to a presenting user and for tracking viewing thereof includes receiving a personal branding video and other related information of the presenting user. For each of a plurality of viewing sessions, the personal branding video of the presenting user is played back while also displaying a plurality of interactive objects that link to the related information. Interactions, such as selecting interactive objects, by viewing users during the viewing sessions are detected and a log entry is stored for each detected interaction. Each log entry indicates the type of the interaction and the playback time of the video at the moment of the detected interactions. Reports may be generated from the stored log entries, which provide information about how the personal branding video and the related information was viewed by the viewing users.

### RELATED PATENT APPLICATION

The present application claims priority from U.S. provisional patent application No. 62/272,089, filed Dec. 29, 2015 and entitled “PROFESSIONAL BRANDING SOCIAL PLATFORM & SOFTWARE COMPRISING AN INTERACTIVE PORTFOLIO CREATION AND SHARING”, the disclosure of which is hereby incorporated by reference in its entirety.

### TECHNICAL FIELD

The present disclosure generally relates to a computer-implemented platform enabling management of (ex: building, storing and presenting) personal branding of users, and more particularly, a platform in which the user can present a video and documents for personal branding and track viewing of the video and/or documents.

### BACKGROUND

The traditional method for presenting information to others is via a static presentation of information. For example, in the job-seeking context, a candidate would present information about himself/herself in the form of a text-based cover letter and/or resumé. Similarly, when an entrepreneur seeks to promote a project, a written business plan is usually prepared.

However, text-based documents are static and may not always effectively provide information about a person's personality. Video presentations, such as video resumés, seek to fill this gap. However, video presentations sometimes lack the necessary factual information found in plain text documents.

Moreover, the distribution of text-based documents (ex: resumés, cover letters, business plans) and video presentations rely on traditional communication means, such as email. These communication means may not always effectively link the information found within a video with information found in the text-based documents, and vice versa.

### SUMMARY OF THE INVENTION

According to one aspect, there is provided a method for presenting information associated to a user and for tracking viewing thereof. The method includes receiving a plurality of textual information entries associated to a user and receiving a video associated to the user. The method includes, for each of a plurality of viewing sessions associated to the user: playing back, within a user interface, the video associated to the user; displaying, within the user interface during the playing back, a plurality of interactive objects, at least one of the interactive objects being linked to a subset of the textual information entries associated to the user; detecting during the playing back of the video one or more interactions within the user interface by a viewer of the session; and in response to each detected interaction by the viewer, storing a log entry for the detected interaction, the log entry indicating a type of the interaction and a playback time of the video at the moment of the detected interaction.

According to another aspect, there is provided a computer system having at least one data storage device and at least one processor operably coupled to the at least one storage device. The at least one processor is configured for receiving a plurality of textual information entries associated to a user and receiving a video associated to the user. The processor is further configured for each of a plurality of viewing sessions associated to the user: playing back, within a user interface, the video associated to the user; displaying, within the user interface during the playing back, a plurality of interactive objects, at least one of the interactive objects being linked to a subset of the textual information entries associated to the user; detecting during the playing back of the video one or more interactions within the user interface by a viewer of the session; and in response to each detected interaction by the viewer, storing a log entry for the detected interaction, the log entry indicating a type of the interaction and a playback time of the video at the moment of the detected interaction.

### BRIEF DESCRIPTION OF THE DRAWINGS

FIG. 1 illustrates a schematic diagram of a personal branding management system 1 according to an example embodiment;

FIG. 2 illustrates a flow chart diagram of a method for the creation of a personal branding portfolio according to an example embodiment;

FIG. 3A illustrates an example from a processed personal branding video having the background scene removed;

FIG. 3B illustrates a screenshot of a raw personal branding video;

FIG. 3C illustrates the screenshot of the raw personal branding video of FIG. 3B having the background scene removed;

FIG. 3D illustrates a screenshot of a personal branding video having a 3-D reconstruction of the user's head in a first orientation and the background scene removed;

FIG. 3E illustrates a screenshot of the personal branding video having the 3-D reconstruction of the user's head in a second orientation and the background scene removed;

FIG. 3F illustrates a screenshot of the personal branding video having the 3-D reconstruction of the user's head in a third orientation and the background scene removed;

FIG. 3G illustrates a screenshot of the personal branding video having the 3-D reconstruction of the user's head in a fourth orientation and the background scene removed;

FIG. 3H illustrates a replacement background according to one example embodiment;

FIG. 3I illustrates a screenshot of the personal branding video having the 3-D reconstruction of the user's head in a first orientation over the replacement background;

FIG. 3J illustrates a screenshot of the personal branding video having the 3-D reconstruction of the user's head in a second orientation over the replacement background;

FIG. 3K illustrates a screenshot of the personal branding video having the 3-D reconstruction of the user's head in a third orientation over the replacement background;

FIG. 4 illustrates a block diagram of a data structure for storing personal branding portfolio for a presenting user according to one example;

FIG. 5 illustrates a flow chart diagram of a method for the presenting and tracking of a viewing session according to one example;

FIG. 6 illustrates a user interface displayed on a user device during playback of a personal branding video according to an example embodiment;

FIG. 7A illustrates a block diagram of a data structure of stored log entries for tracked interactions according to an example embodiment;

FIG. 7B illustrates a block diagram of a data structure of stored log entries for tracked interactions according to an alternative example embodiment;

FIG. 8 illustrates a flow chart diagram of a method for the reporting of viewing history;

FIG. 9 illustrates a flow chart diagram of a method for the reporting of viewing history by playback time; and

FIG. 10 illustrates is an example of a user interface for reporting on past viewing sessions.

### DETAILED DESCRIPTION

Broadly described, various example embodiments described herein provide for a system and method for presenting personal branding portfolio of a presenting user, in which a personal branding video of the user is displayed. The viewing of the personal branding portfolio is tracked in stored log entries and one or more reports on the viewing sessions of the personal branding portfolio may be generated.

One or more systems and methods described herein may be implemented in computer programs executing on programmable computers, each comprising at least one processor, a data storage system (including volatile and non-volatile memory and/or storage elements), at least one input device, and at least one output device. For example, and without limitation, the programmable computer may be a programmable logic unit, a mainframe computer, server, and personal computer, cloud based program or system, laptop, personal data assistance, cellular telephone, smartphone, wearable device, tablet device, virtual reality devices, smart display devices (ex: Smart TVs), set-top box, video game console, portable video game devices, or virtual reality device.

Each program is preferably implemented in a high level procedural or object oriented programming and/or scripting language to communicate with a computer system. However, the programs can be implemented in assembly or machine language, if desired. In any case, the language may be a compiled or interpreted language. Each such computer program is preferably stored on a storage media or a device readable by a general or special purpose programmable computer for configuring and operating the computer when the storage media or device is read by the computer to perform the procedures described herein. In some embodiments, the systems may be embedded within an operating system running on the programmable computer.

“Presenting user” herein refers to a user registered within the personal branding management system seeking to present information of himself or herself. As described herein, the presenting user creates a personal branding portfolio that includes one or more personal branding videos and related information entries intended to be viewed by viewing users.

“Viewing user” herein refers to a user that accesses the branding management system to view personal branding portfolios of presenting users to obtain information about the presenting users.

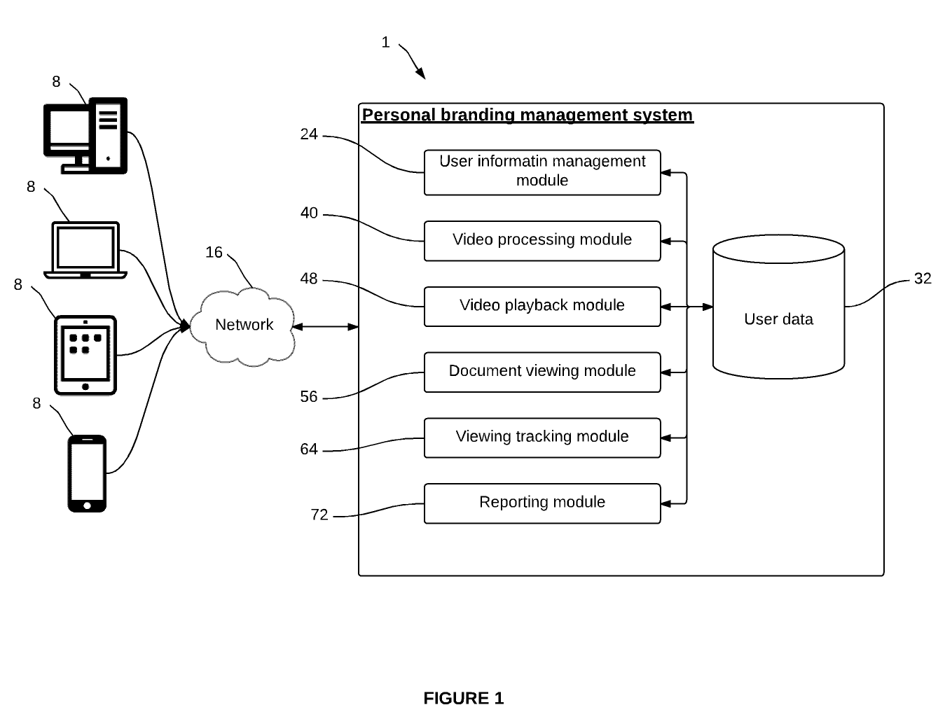

Referring now to FIG. 1, therein illustrated is a personal branding management system 1 according to an example embodiment having a plurality of user device 8 connected thereto over a network 16. For example, the user device 8 could be a laptop, personal data assistant, smart phone, desktop computer, tablet, set-top box, video game console, or virtual reality headset. For example, the user device 8 can run one or more of a variety of operating systems or platforms, such as Windows, Mac OS, OS X, iOS or Android.

The user devices 8 may be connected to the personal branding management system 1 via any suitable communications channel. For example, the computing may communicate over the network 16 that is a local area network (LAN) or Intranet) or using an external network, such as, by the Internet. Communication may be carried out using a standalone app or a browser operating on the user device. It will be appreciated that communication between the user devices 8 and the personal branding management system 1 may be carried out over a wired network, wireless network, or a combination thereof.

In some cases, one or more human users interacting with the user devices 8 may be required to authenticate their identities in order to communicate with the personal branding management system 1. For example, the user devices 8 may be required to input a login name and/or a password or otherwise identify themselves to gain access to the personal branding management system 1.

In other cases, one or more users (e.g. “guest” users) may be able to access the page-generating system 8 without authentication. Such guest users may be provided with limited access, such as access to a limited set of features.

The personal branding management system 1 generally includes a number of functional components for providing the service of managing a personal brand. For example, the page-generating system 8 generally includes one or more processing devices (ex: servers, workstations), each having one or more processors. The processing devices are configured to carry out various computing steps, as described elsewhere herein. The processing devices are also configured to send information (ex: HTML or other data) to be displayed on the one or more user devices 8.

The personal branding management system 1 also generally includes one or more data storage devices (ex: memory, etc.) that are in communication with the processing devices, and could include a relational database (such as a SQL database or NoSQL database), or other suitable data storage devices. The data storage devices are configured to host data related to the personal branding management, as described elsewhere herein. The data storage devices are configured to also store user-related information.

It will be understood that while the personal branding management system 1 according to various examples is described herein in a job-seeking context in which a user is managing their personal brand in order to find a job, the personal branding management system 1 may also be applied for situations other than job-seeking. For example, the personal branding management system 1 may be used by a user to showcase their talents, such as by an artist, model, actor, musician, or an athlete. The personal branding management system 1 may also be used by a business or entrepreneur to showcase their suitability for a project or contract. The personal branding management system 1 may also be used by a presenting user to make a pitch, such as a sales pitch. The sales pitch may be a pitch for a product or service. In one example, the product may be a real estate property (ex: house, commercial building, etc.)

Continuing with FIG. 1, a block diagram of the example embodiment of the personal branding management system 1 is illustrated. The personal branding management system 1 includes a plurality of modules, which may be implemented in hardware or software or a combination of both on the processing devices.

The personal branding management system 1 includes a user information management module 24 that provides management of information of a user registered within the system 1. For example, the user information management module 24 provides functionality that allows a presenting user, such as job candidate, to create, upload, and edit various types of information related to the user. Information related to the user can be stored with the user database 32 of the personal branding management system 1 in logical association with an account for the user.

The information related to the presenting user includes at least textual information, which herein refers to information provided in the form of text. The textual information may be stored within the user database 32 as one or more textual information entries. The textual information entries can be categorized by their respective type when stored within the user database 32.

In the context of a user being a job candidate seeking a job, a first type of textual information entries can be “professional” type, and can include entries such as resumé, diploma, transcript, cover letter, and letter recommendation, etc. A second type of textual information entries can be “skills”, type and can include entries such as software skills, interpersonal skills, technical certifications (ex: first-aid certification), etc. A third type of textual information entries can be “interests” type and can include entries such as personal causes, volunteering activities, and hobbies. A fourth type of textual information entries can be “contact” type and can include entries such as address, telephone number, email, and social network contacts, etc.

The information related to the user can also include non-textual (i.e. multimedia) information, such as images, videos, or designs related to the user. These may correspond to a portfolio type of information related to the user. Portfolio type of information may be useful to showcase a user's talent, such as performances by an actor or musician, highlights by an athlete, artistic work by an artist or designs, presentation slides, articles, apps by, for example, a graphical designer, web designer or architect.

The personal branding management system 1 also includes a video processing module 40 that is configured to receive and process a video denoted as a personal branding video of the presenting user. This personal branding video is intended to present information about the presenting user in a video form to viewing users that would like to learn about the user in the video. The personal branding video is processed and stored independently from any videos stored within the portfolio type of information related to the presenting user. Various types of processing the personal branding video is described elsewhere herein.

The brand management system 1 also includes a video playback module 48 that is operable to playback the personal branding video of a presenting user to one or more viewing users accessing the branding management system 1 via a user device 8. As described herein, the video playback module 48 provides playback of the personal branding video of a given presenting user within an interactive user interface that allows integrated access to related information entries of the same given presenting user.

The personal branding management system 1 further includes a document viewing module 56 that is operable to display, on a user device 8 being used by a viewing user, information entries related to a presenting user. As described elsewhere herein, the document viewing module 56 retrieves the relevant information entry from the user database 32 in response to a request by a viewing user through an interaction within the user interface while the personal branding video for the presenting user is being played back.

The personal branding management system 1 also includes a viewing tracking module 64 that is operable to tracking viewing sessions by one or more viewing users of the personal branding video of a particular presenting user and the related information of that presenting user.

The personal branding management system 1 further includes a reporting module 72 that is operable to analyze data generated from tracking the viewing sessions of a given presenting user and to report on the viewing sessions.

The personal branding management system 1 may be implemented as an online platform, such as a website, app or social network platform. The online platform may be accessed presenting users to create, edit and manage their personal branding portfolio. The online platform may also be accessed by viewing users to view personal branding portfolios of presenting users registered to the platform. As described elsewhere herein, this may be useful for human resources (recruitment and placements), professional networking, entrepreneurship promotion, for commercial purposes and entertainment.

A presenting user may link to their personal branding portfolio on the personal branding online platform such that the personal branding portfolio acts as an electronic business card of that user. Viewing users accessing the portfolio can quickly obtain information about the user from viewing the presenting user's personal branding video and related information. For example, the personal branding portfolio may be accessed via a link provided in the presenting user's website, electronic email signature or within another online social networking platform.

According to an embodiment, the online platform can be accessed through an API that integrates to applicant tracking systems or to businesses websites in career sections, in the form of widget on job offers This will be used to help recruiters screen candidates and allows candidate to present themselves virtually before a face to face.

The online platform allows presenting users to carry out personal branding principally through a personal branding video that serves to highlight their qualities. Furthermore, the online platform provides viewing users viewing the personal branding video of a presenting user to easily access related information of that user.

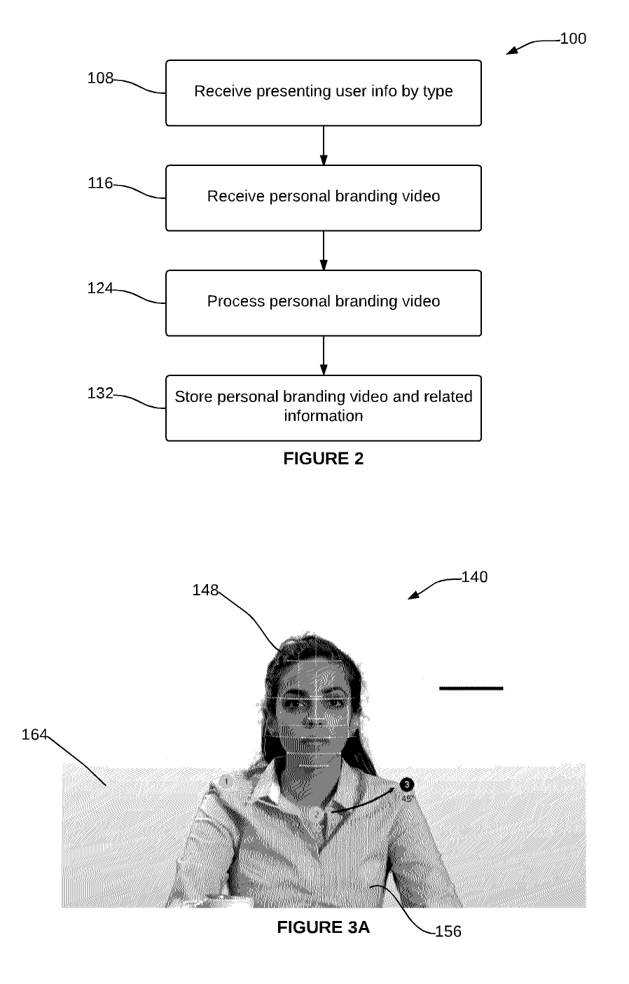

Referring now to FIG. 2, shown therein is a flow chart diagram illustrating an example embodiment of a method 100 for the creation of a personal branding portfolio for a given presenting user. For example, the creation of the personal branding portfolio may be carried out by the information management module 24 and/or the video processing module 40.

At step 108, one or more pieces of information related to the presenting user are received. For example, these pieces of information may be received via the presenting user using a user device 8 to access the personal branding management system 1 in which a creation user interface is presented on the user device 8. The related information may be received via the user uploading documents to the management system 1 and/or using tools provided within the user interface (ex: textboxes, etc.) to enter information. For each piece of information, the user may identify a type of that piece of information. For example, in the context of job seeking, one or more documents of the types “professional”, “skills”, “interest”, “contacts” and “portfolio” can be received at this step.

At step 116, a raw version of the personal branding video is received. The raw version of the personal branding video may be recorded using an image capture device, such as a camera (ex: webcam, smartphone/tablet camera) of the user device 8 being used by the presenting user creating their personal branding portfolio. Typically, the raw personal branding video will include captured images and sound of the presenting user orally presenting information about their self.

According to one example embodiment, the user interface for creating the personal branding portfolio may present a guide, such as a wizard tool, that presents one or more suggested questions and that includes data entry sections that allows the presenting user to enter answers to the questions. After entering answers, the information management module 24 can control the image capture device of the user device 8 to begin recording while playing back the answers within the user interface on the display device of the user device 8. This provides a teleprompter of the answers to guide the present user in giving the oral presentation that will form the present branding video.

According to an embodiment, the length of the personal branding video may be limited in time (e.g. mainly 30 seconds, elevator pitch or to 1 minute). A concise video may be more effective at keeping viewing users interested than videos of longer durations.

At step 124, processing of the raw version of the personal branding video may optionally be carried out. The processing may enhance visual or sound characteristics of the personal branding video.

At step 132, the personal branding video (raw version or processed version) and the received related information are stored within the user database 24. The personal branding video and the related information entries are logically associated with a user ID or user account for the presenting user within the database 24. The stored personal branding video and the related information entries form the personal branding portfolio for that presenting user.

According to one example embodiment, the processing of the raw personal branding video at step 116 includes removal of background within the raw personal branding video. A raw personal branding video will typically have captured images of the presenting user's head and torso. Within the background removal, the torso and the head are detected as foreground objects within the video. Areas other than the torso and the head of the user are detected as background scene within the video. The raw personal branding video is processed to remove pixels corresponding to the background scene. For example, these pixels can be identified as “transparent” pixels.

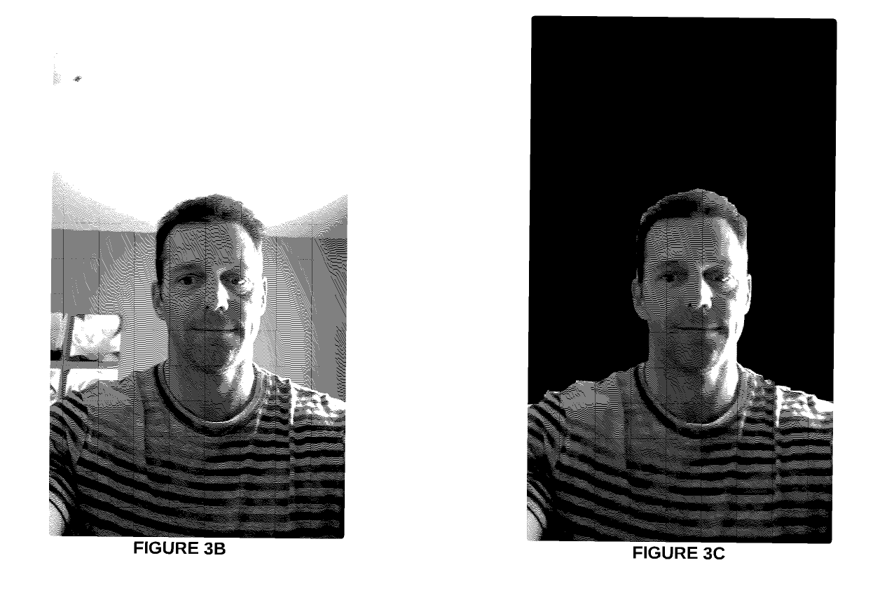

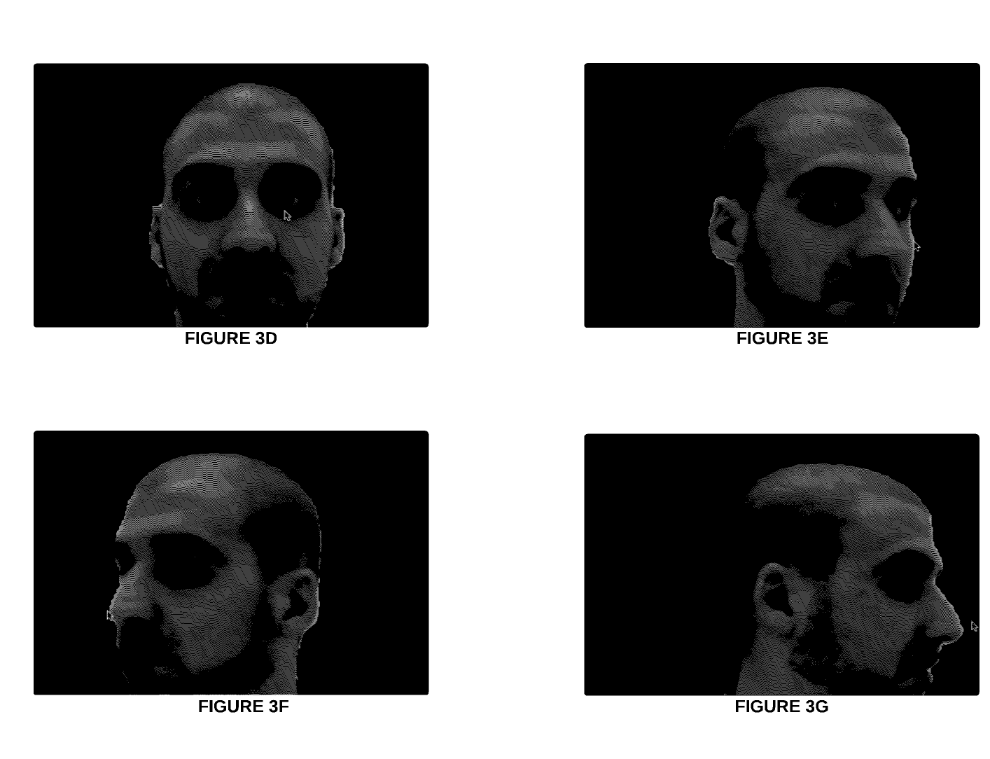

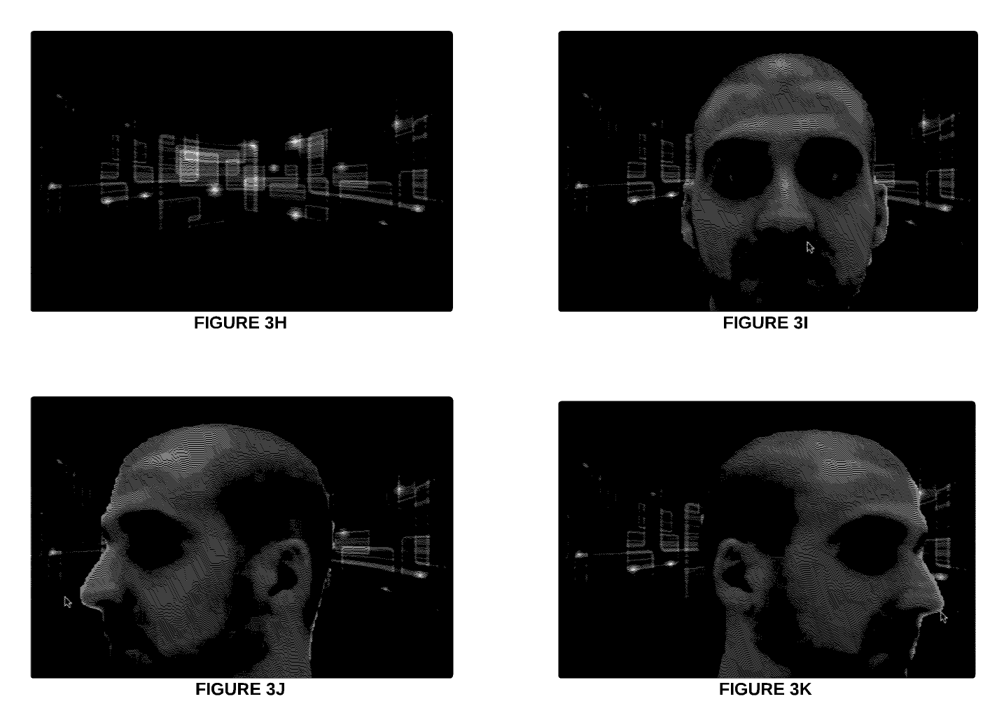

Referring now to FIG. 3A, therein illustrated is an example frame of a processed personal branding video in which the presenting user's head 148 and torso 156 are detected as foreground objects and areas surrounding the head 148 and torso 156 are detected as the background scene. The background scene which may be distracting for a viewer has been removed and replaced with a neutral background 164 in the illustrated example.

In some example embodiments, a replacement background scene may be inserted in place of the removed background scene. Advantageously, the insertion of the replacement background scene can provide the personal branding video with a more professional look (ex: to correct where the raw personal branding video is recorded in a personal space, such as a bed room).

The replacement background scene may be a static scene or an immersive scene. The immersive replacement background scene may have one or more moving visual features. For example, the presenting user can select at step 124 the replacement background to be used (ex: color, pattern, or type of immersive background scene). The properties of the replacement background may be chosen to match a user selected personality trait.

According to an embodiment, images of the presenting user appear as “floating” over any background. The processing of the personal branding video by removing the background scene facilitates the task of generating a personal branding video having a professional appearance without requiring a professional studio or green screens.

The removal and/or replacement of the background scene may be carried out in real-time while the personal branding video is being recorded so that the presenting user can have immediate visual feedback.

Referring now to FIG. 3B, therein illustrated is a screenshot of a raw personal branding video in which a presenting user in the personal video is looking into the image capture device.

FIG. 3C illustrates a screenshot of the personal branding video of FIG. 3B in which the background scene has been removed.

According to another example embodiment, the processing of the raw personal branding video includes determining a three-dimensional (3-D) profile of the presenting user's head and generating a 3-D reconstruction of the user's. Accordingly, a 3-D interactive video is created, whereby during playback of the personal branding video, the head and face of the presenting user can be viewed from different angles. This allows viewing in a 3-D environment, such as when using a virtual reality device, such as Oculus Rift or Hololens. During playback, the viewing user is given the sense that the presenting user is within the same virtual environment and further allows the viewing user to navigate within the environment.

For example, prior to recording of the raw personal branding video, images of the presenting user's head may be captured from various angles and a 3-D reconstruction of the user's head is generated from the captured images. The presenting user then uses the image capture device to record the raw personal branding video. The raw personal branding video is then processed to animate the 3-D reconstruction of the user's head in accordance with the user's motion in the raw personal video. During playback of the personal branding video, the animation of the user's head is displayed, in which the 3-D reconstruction of the user's head is viewable from all angles. Advantageously, the 3-D reconstruction may provide a further level of engagement between the viewing user and the presenting user.

Referring now to FIGS. 3D, therein illustrated are screenshots of the 3-D reconstruction of the user's head within a personal branding video being played back on a 2-D display. As illustrated, a viewing user can manipulate the viewing angle of the 3-D reconstruction of the user's head by controlling the illustrated cursor. For example, as the cursor is clicked and dragged, the 3-D reconstruction of the user's head is rotated within the display.

The 3-D reconstruction of the user's head may be viewed as a virtual reality 3-D object when the personal branding video is played back on a virtual reality device, such an Oculus Rift, Hololens or HTC Vive. The 3-D reconstruction of the user's head and body may be placed in a virtual reality environment. The user viewing the personal branding video on the virtual reality device can navigate the virtual reality environment during playback of the personal branding video. In one example, the presenting user can choose the virtual reality environment in which the 3-D reconstruction of the user's head is presented. 3-D interactive graphical objects linking to related information of the presenting user may also be placed in the virtual reality environment. The viewing user can interact with the 3-D graphical objects while navigating the virtual reality environment.

The presenting user can customize the virtual environment, such as adding visual 3-D interactive objects within the environment that provide access to related information of the presenting user, such as their professional type, skills type, interests type, contacts type and/or portfolio type related information entries.

In one example of a virtual environment, there may be corridors which can be navigated by the viewing user by touching the screen or a real environment like an office, a recording studio, In the example, doors can be provided in the virtual environment, which the user may use to access other content (virtual and augmented reality) The viewing user can thus explore the links embedded in the background/foreground. For example, by clicking/touching on a door, the particular related information entry of the presenting user can be presented, while another door may lead to another related information entry of the presenting user.

In another example, a virtual and tactile touch cloud can be arranged around the 3-D reconstruction of the presenting user, wherein the virtual cloud comprises icons or links informing the viewing user about the presenting user.

Referring now to FIG. 3H, therein illustrated is a replacement background according to an example embodiment. FIG. 3I to FIG. 3K shows the 3-D reconstruction of the presenting user's head placed over the replacement background.

In one particular example embodiment, the presenting user is a real estate agent and the personal branding portfolio is presented in a real estate context. The personal branding video may be a video of the presenting user orally describing a real estate property. A 3-D reconstruction of the user's full body is generated. The 3-D reconstruction is then placed in a virtual environment that is 3-D reconstruction of the real estate property, such as 3-D reconstructions of one or more rooms of a house. A viewing user viewing the personal branding video within the virtual environment representing the real estate property on a virtual reality device will have the impression of standing inside the real estate property alongside the 3-D reconstruction of the real estate agent. The virtual reconstruction of the real estate property may further be virtually navigated by the viewing user within the virtual reality device. Advantageously, this presentation will increase engagement of the viewing user with the real estate agent and the real estate property. One or more interactive objects within the virtual environment can be navigated by the viewing user to access related information of the real estate agent and/or the real estate property, such as biography of the real estate agent and properties of the real estate property (ex: age of house, dimensions, selling price, etc.)

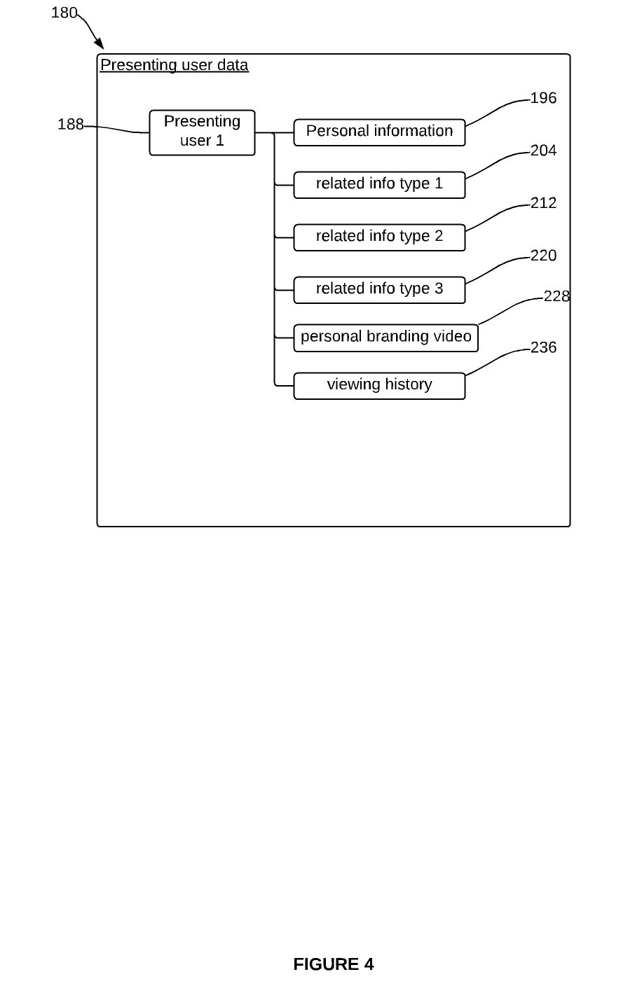

Referring now to FIG. 4, therein illustrated is a block diagram of a data structure 180 for storing a personal branding portfolio for a given presenting user within the user database 24. A presenting user entry 188 for identifying the presenting user is logically associated with personal information entry 196, which stores personal information preferences of the presenting user. The presenting user entry 188 is further associated with one or more related information type entries 204, 212 and 220. These correspond to the related information received at step 108 and are stored by type of related information. In the illustrated example, three types of related information entries are illustrated. The presenting user entry 188 is further associated to the stored personal branding video 228 for the presenting user. The stored personal branding video 228 may already be processed, such as having background removed and/or replaced, or a generated 3-D reconstruction. The presenting user entry 188 is further logically associated with the viewing history 236, which stores the history of interactions by viewing users while viewing the personal branding portfolio for the presenting user, as described elsewhere herein. Logical association between entries form a link between entries and allows a second entry to be accessed from a first entry logically associated to it.

Once a presenting user has completed the creation of their personal branding portfolio, it is made available for viewing by other viewing users.

A viewing user reviews the presenting branding portfolio of a presenting user within a viewing session. During the viewing session, the personal branding video is played back within a user interface displayed on a display device of a user device 8 being used by the viewing user. A viewing session corresponds to the time period between the viewing user requesting to review the personal branding portfolio and the viewing user terminating the review of that personal branding portfolio.

During the viewing session, one or more interactions by the viewing user are detected, for example, by the viewing tracking module 64. A log entry is further created for each of the one or more interactions. The stored log entry for an interaction indicates at least a type of the interaction at the playback time of the personal branding video at the moment of the interaction. The log entries may be used for generating reports to provide information about the viewing history of the personal branding portfolio of that presenting user.

During the viewing session, the personal branding video is played back within the user interface viewed by the viewing user in which at least one interactive object linking to a subset of related information entries is also displayed. A first type of interaction is the viewing user interacting with (ex: clicking with mouse, selecting with finger on touchscreen display device, or touching in a virtual environment) an interactive object to view the related information entries linked to that interactive object.

A second type of interaction is the viewing user exiting the viewing of the personal branding video and terminating the reviewing of that personal branding portfolio prior to the playback of the personal branding video reaching the end of the video.

A third type of interaction is the playback of the personal branding video reaching the end of the video, indicating that the viewing user viewed the entire personal branding video.

A fourth type of interaction is the entering of feedback by the viewing user while viewing the personal branding video. The viewing user may also indicate a particular interval of time to which the feedback pertains.

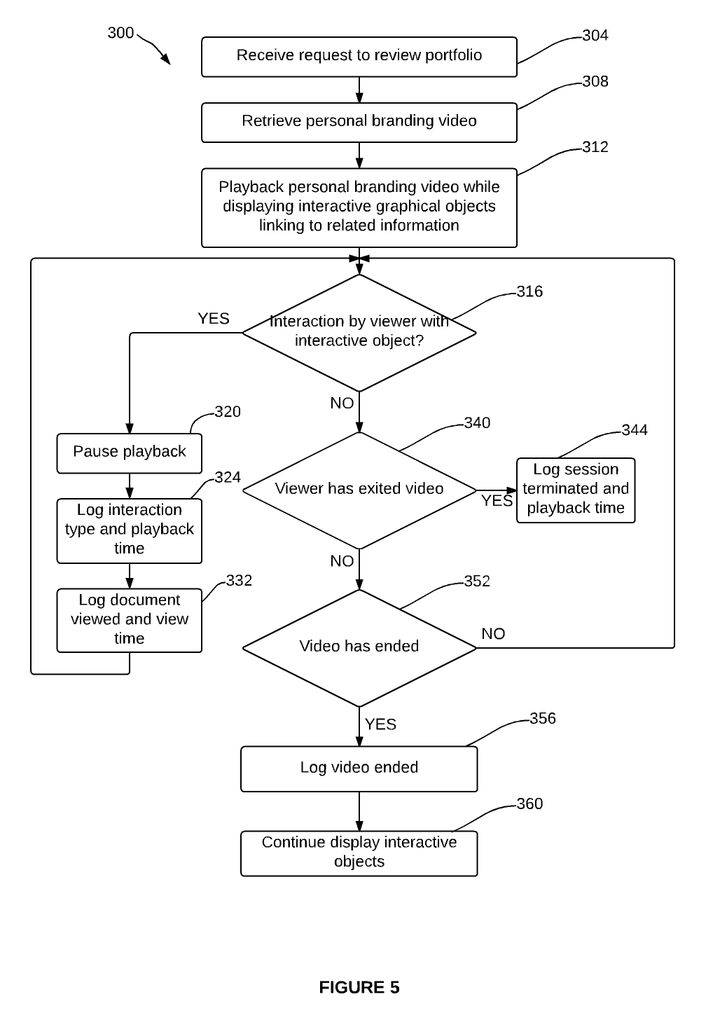

Referring now to FIG. 5, therein illustrated a flow chart diagram illustrating an example embodiment of a method 300 for the presenting and tracking of a viewing session by a viewing user reviewing the personal branding portfolio of a presenting user. For example, the presenting and the tracking may be carried out by a combination of the video playback module 48, the document viewing module 56 and the viewing tracking module 64.

At step 304, a request is received from a viewing user accessing the personal branding management system 1 to view the personal branding portfolio of a given presenting user.

At step 308, the personal branding video for that presenting user stored within the user database 24 is retrieved.

At step 312, the personal branding video is played backed within a user interface displayed on a user device 8 used by the viewing user. During the playback, one or more interactive objects are displayed within the user interface. The interactive objects are linked to related information entries for the presenting user, whereby interaction with an interactive object allows the viewing user to access the related information entries linked to that object interacted with. Where the related information entries include textual information entries, at least one of the displayed interactive objects is linked to one of the textual information entries.

According to one example embodiment, the interactive objects are overlaid on the personal branding video during the playing back of the video. The interactive objects may be graphical objects (ex: icons, images, etc.). Furthermore, where the personal branding video has been processed to remove the background scene, the interactive objects may be overlaid within areas of the video having the background scene removed.

In one example embodiment, the presenting user can select the placement of the graphical interactive objects within the personal branding video when creating the personal branding portfolio. The presenting user can also select how graphical interactive objects are linked to related information entries.

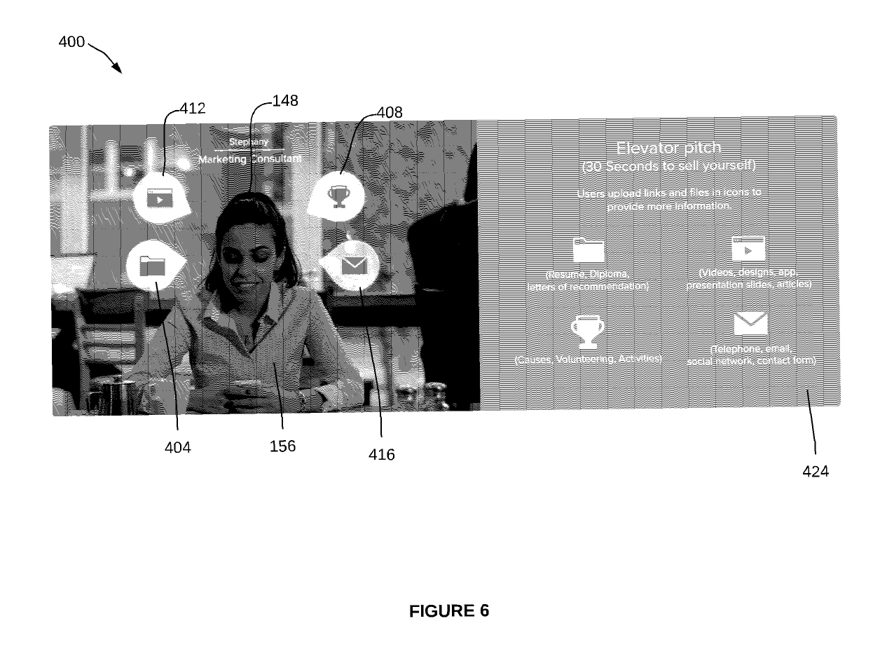

Referring now to FIG. 6, therein illustrated is an example of a user interface 400 displayed on the user device 8 of the viewing user during playback of the personal branding video. A plurality of interactive graphical objects 404, 408, 412, and 416 are overlaid on the video around the head 148 and torso 156 of the presenting user. The illustrated example is for a job seeking presenting user, and the graphical objects 404, 408, 412 and 416 link to related information entries of “professional” type, “interests” type, “portfolio” type, and “contact” type, respectively. Interactive graphical objects may also be displayed in a static navigation area 424 beside the video being played back.

According to example embodiments wherein the raw personal branding video is processed to create a 3-D reconstruction, the 3-D reconstruction of the presenting user may be animated during playback. The 3-D reconstruction may further be manipulated by a viewing user, such as with touch gestures, mouse, arrows, etc.

Referring back to FIG. 5, at step 316, whether an interaction by the viewing user with an interactive object has occurred is detected. If an interaction with an interaction object is detected, the method proceeds to step 320 to pause the current playback of the personal branding video. At step 324, the type of interaction based on the object interacted with and the playback time of the personal branding video at the moment of the interaction is stored within a log entry. For example, the interaction may be the viewing user providing feedback (ex: using an interactive comments textbox), and an interaction of the type “feedback” is logged. For example, the interaction may be the viewing user selecting an interactive object for viewing a particular type of related information and an interaction of the type 1 (ex: “professional” type) “view type 1” (ex: “view professional” type) is logged.

Where the interaction is for viewing a type of related information (ex: “professional” type entries) and a plurality of entries of that type are stored within the personal branding portfolio, a list of the titles of the entries may be displayed within the user interface. The viewing user can then select one of the titles to view the related information entry identified by that title (ex: viewer selects title “cover letter” and the stored cover letter entry is displayed). At step 332, a further log entry may be stored to indicate that that particular information entry is viewed. The amount of time viewing that entry can also be stored.

The viewing user can select to resume viewing of the personal branding video, in which case the method 300 returns to step 316 to detect further interactions by the viewing user.

At step 340, whether the viewing user has terminated the viewing session is detected. If the user has terminated the viewing session, a log entry is stored at step 344 indicating an interaction of the viewing session terminated type and the playback time of the video at the moment of interaction.

At step 352, whether the playback of the personal branding video has reached the end of the video is detected as a type of interaction. If the video has reached the end, a log entry is stored at step 356 indicating an interaction of the video ended type. At step 360, the display of the interactive objects can be continued to allow a viewing user to provide feedback or access related information entries for the user.

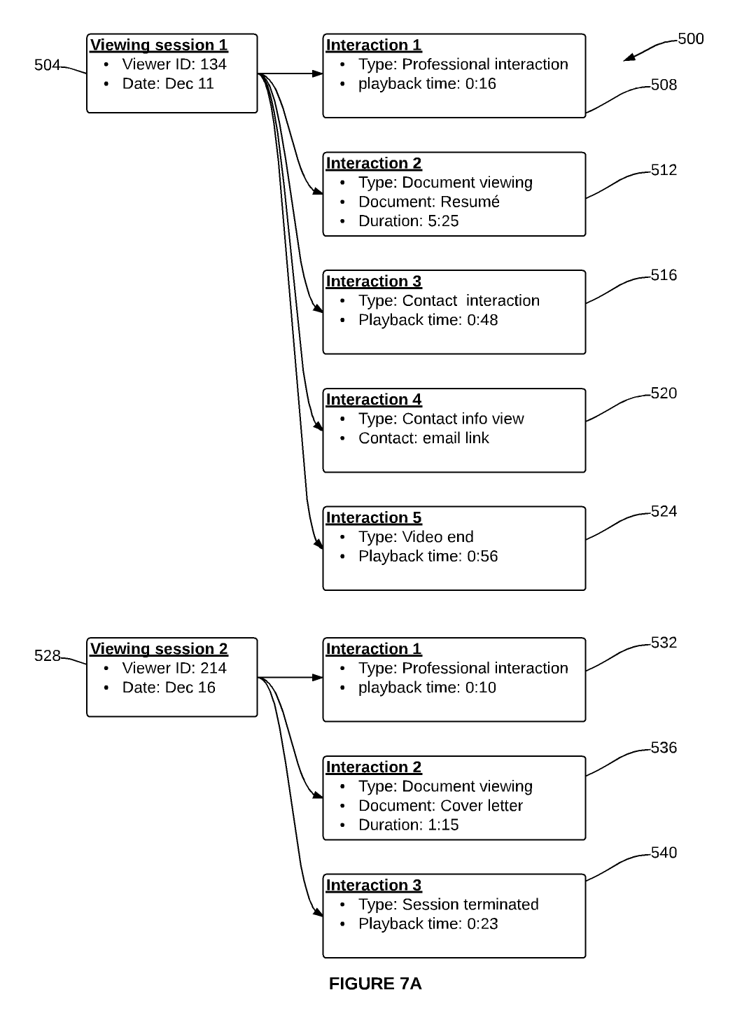

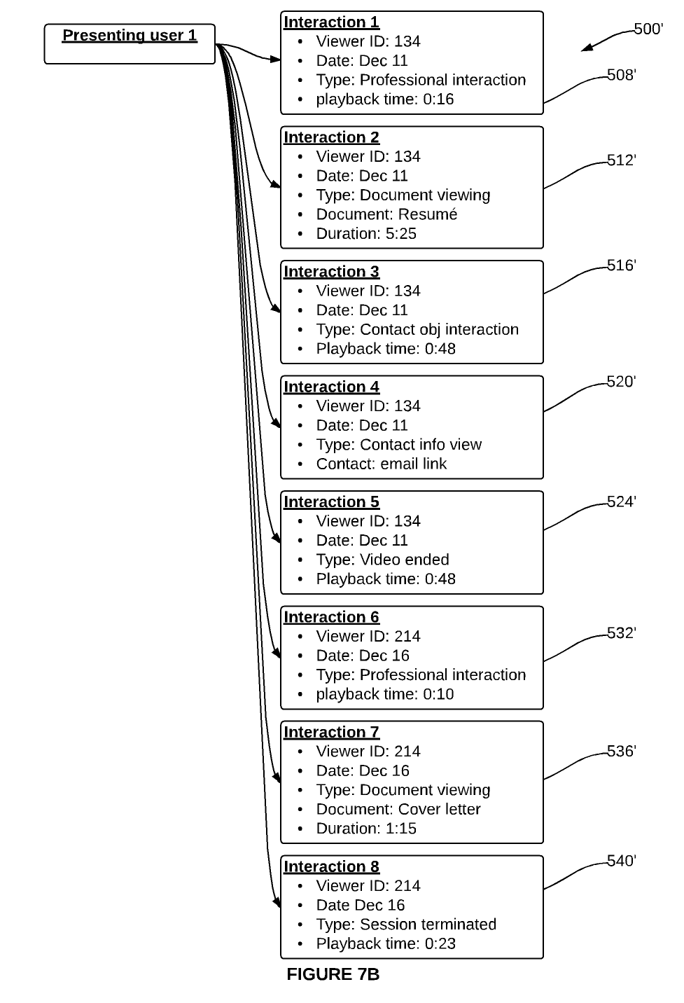

Referring now to FIG. 7A, therein illustrated is a block diagram of a data structure 500 of stored log entries for tracked interactions by viewing users during viewing sessions of the personal branding portfolio of a user. A plurality of stored log entries associated to viewing sessions indicate a type of interaction and a playback time at the moment of the interaction.

A first viewing session entry 504 identifies the ID of the viewing user and the date of the viewing session. A first stored log entry 508 for a first interaction indicates that at playback time 0:16, the viewer interacted with an interactive object linked to “professional” type related information entries. A second stored log entry 512 for a second interaction indicates that as a follow up to the first interaction, the viewing user viewed the “resumé” information entry for 5 minutes and 25 seconds. A third stored log entry 516 for a third interaction indicates that the playback of the personal branding video was resumed and that at playback time 0:48, the viewer interacted with an interactive object linked to “contact” type related information entries. A fourth stored log entry 520 for a fourth interaction indicates that as a follow up to the third interaction, an email was sent by the viewing user to the presenting user. A fifth stored log entry 524 indicates that playback of the personal branding video was resumed and that the playback reached the end of the video.

A second viewing session entry 528 identifies the ID of a second viewing user and the date of a second viewing session. A first stored log entry 532 associated to the second viewing session entry 528 indicates that in a first interaction of the second viewing session, an interactive object linked to “professional” type related information entries was interacted with. A second stored log entry 536 for the second viewing session entry 536 indicates that a textual information entry “cover letter” was viewed for 1 minute and 15 seconds. A third log entry 540 for the second viewing session entry 540 indicates that at playback time 0:23, the viewing session was terminated.

Referring now to FIG. 7B, therein illustrated is a block diagram of an alternative data structure 500′ of stored log entries for tracked interactions by viewing users during viewing sessions of the personal branding portfolio of a user. The stored log entries 504′, 508′, 512′, 516′, 520′, 524′, 528′, 532′, and 536′ indicate the same interactions as the example of data structure 500 but the viewing user ID and the date of the viewing session is embedded within each stored log entry. A viewing session may be reconstructed by merging all stored log entries that have the same viewing user and the same viewing date.

It will be appreciated that the stored log entries provide information about the viewing sessions. For example, the stored log entries can be used to analyze how successful the personal branding video of the presenting user is at retaining the attention of viewing users. In the illustrated example, the stored log entries show that the first viewing user was more interested than the second viewing user because the first viewing user viewed more of the personal branding video and spent longer viewing related information.

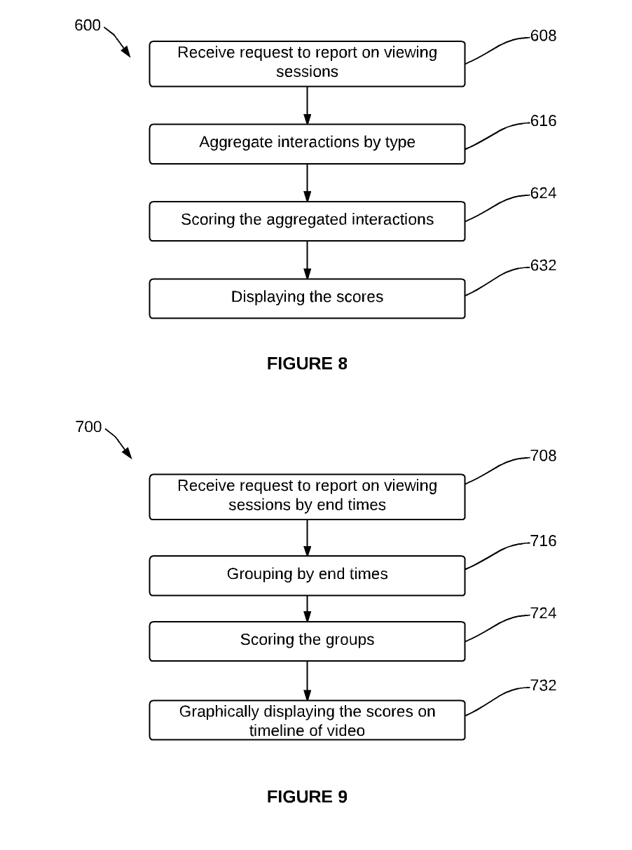

Referring now to FIG. 8, shown therein is a flow chart diagram illustrating an example embodiment of a method 600 for the reporting of viewing history by viewing users of a personal branding portfolio of a given presenting user.

At step 608, a request is received from the presenting user to generate a report about viewing sessions carried out on the personal branding portfolio.

At step 616, in response to receiving the request, log entries stored across multiple viewing sessions can be grouped together. For example, the stored log entries can be grouped by the type of interaction indicated within the stored log entries.

At step 624, a score is determined for each group of log entries.

At step 632, the scores for each group is displayed. For example, for a group of log entries of a type where viewers interact with a graphical interactive object, the score may be graphically displayed on the personal branding video next to the graphical interactive object.

In one example embodiment, the score of group of log entries for a particular type of interaction may be determined as the percentage of times that type of interaction occurred within a viewing session. This information may be useful for a presenting view who is reviewing the performance of their personal branding video to determine how successful their video is at getting a viewing user to perform that type of interaction. For example, a job seeking presenting user will want to see the percentage of times a viewing user decided to view “professional” type related information while viewing the personal branding video. The presenting user can then target areas for improving the personal branding video. For example, the job seeking presenting user may notice that viewing users are not viewing the “professional” type related information often enough and they may edit their personal branding video to specifically invite viewing users to select an interactive object linking to the “professional” type related information.

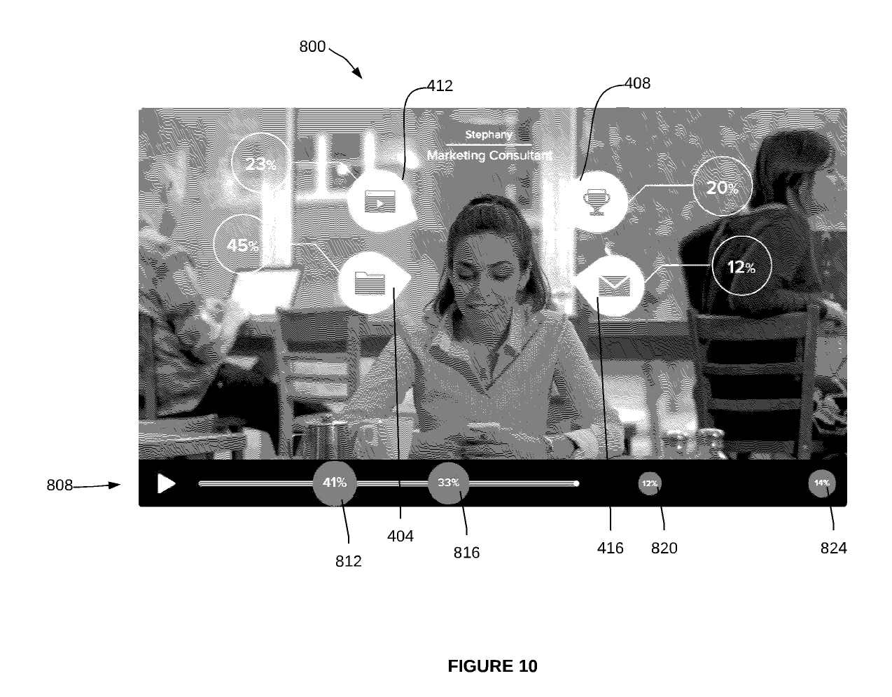

Referring now to FIG. 10, therein illustrated is an example of a user interface 400 displayed on the user device 8 for reporting on viewing sessions. It will be appreciated that scores for four types of related information are displayed graphically next to the graphical interactive objects that link to that type of related information. In the illustrated example 45% of viewing sessions included a viewing user interacting with the interactive object 404 linking to “professional” type related information, 23% to “portfolio” type related information, 20% to “interests” type related information” and 12% to “contract” type related information.

According to one example embodiment, the log entries stored across multiple viewing sessions can be grouped by the type of interaction and by the playback time. For example, the score of a group of log entries for a particular type of interaction and a particular playback time may be determined as the percentage of times that type of interaction occurred within a viewing session before the playing back of the personal branding video reaching that particular playback time. This may be useful to indicate how successful the personal branding video is at getting viewing users to view related information entries of different types by a particular playback time in the video.

Referring back to FIG. 10, the displayed scores may correspond to the percentage of times that that graphical object was interacted with prior to the playback time indicated by the playback cursor 804 within the playback timeline 808.

Referring now to FIG. 9, shown therein is a flow chart diagram illustrating an example embodiment of a method 700 for the reporting of viewing history by viewing users of a personal branding portfolio for the playback time at the moment the viewing session is terminated.

At step 708, a request is received from the presenting user to generate a report about viewing sessions carried out on the personal branding portfolio based on playback time of the video at the moment the viewing session is terminated.

At step 716, in response to receiving the request at step 708, the log entries are grouped according to their playback times at the moment the viewing session is terminated.

At 724, a score is determined for each group of log entries.

At step 732, the scores for each group is displayed. In one example embodiment, the scores may be displayed on a graphical timeline 808 of the personal branding video. For example, the scores may indicate the number of viewing sessions lasting past each one or more playback times corresponding to a given position of the displayed score on the graphical timeline.

The scoring based on playback time at the moment of viewing sessions being terminated may be determined for both the type of interaction where a viewing session is terminated prior to the personal branding video reaching its end and for the type of interaction where the playback of the personal branding video reaches the end of the video.

Referring back to FIG. 10, a first graphical score 812 at a first position on the graphical timeline 808 indicates that for 41% of viewing sessions, the playback of the person branding video lasted past the playback time corresponding to the first position on the timeline 808. Second graphical score 816 indicates that for 33% of viewing sessions, the playback lasted past the second position on the timeline 808. Third graphical score 824 indicates that for 12% of viewing sessions, the playback lasted past the third position on the timeline 808. The third graphical score 824 indicates that for 14% of viewing sessions, the playback of the personal branding video reached the end of the video. The positions of the scores on the graphical timeline may correspond to predefined milestones within the video. These may be defined by the presenting user during creation of the personal branding video. For example, these milestones may correspond to the start of a new subject of the oral presentation by the presenting user captured in the personal branding video.

The personal branding management system 1 may also include other metrics that aid a presenting user to assess the performance of their personal branding portfolio. For example, system can track how viewing users arrived at the personal branding social platform (ex: from another website or social platform) and accessed the personal branding portfolio of that user.

Advantageously, various systems and methods described herein allows a presenting user to improve their engagement with viewing users. For example, the personal branding video allows viewing users to literally see and hear a presenting user. For example, for a presenting user who is seeking a job, personal branding video allows the user to more effectively share his/her story, past experiences, interests, evidence of his/her talent and communication skills, personality and charisma, as if the candidate was in front of a recruiter who is the viewing user. This may help the presenting user who is a candidate for a job to stand out among others and impress potential employers. The interactive objects within the playback of the personal branding video allows a viewing user to quickly access related information to the presenting user, such as their resume, skills, interests, or portfolio.

The personal branding system 1 can be used to assist career consultants in universities to help students improve their professional brand during their process of job search. It can also help agencies place their job searchers with clients sharing their portfolios before a face-to-face interview.

The personal branding system 1 also provides a pre-screening tool for employers to evaluate a fit with a company (values, attitude, mission), which can be a lot more valuable than the usual paper resume and pre-screening calls. This is also a great tool for an inexperienced job seekers who can overcome a lack of experience (ex: “thin” resumé) by presenting other qualities within the personal branding video.

Furthermore, the systems and methods described herein provide tools that allows a presenting user to receive reports on the viewing history of their personal branding portfolio, which they can use to make targeted improvements of their personal branding video or other related information.

According to an embodiment, when the online platform for the personal branding system is under use, it can be operated under at least one privacy mode. For example, the user may choose between three modes, such as an open mode, a limited-privacy mode and a private mode.

Several alternative embodiments and examples have been described and illustrated herein. The embodiments of the invention described above are intended to be exemplary only. A person skilled in the art would appreciate the features of the individual embodiments, and the possible combinations and variations of the components. A person skilled in the art would further appreciate that any of the embodiments could be provided in any combination with the other embodiments disclosed herein. It is understood that the invention may be embodied in other specific forms without departing from the central characteristics thereof. The present examples and embodiments, therefore, are to be considered in all respects as illustrative and not restrictive, and the invention is not to be limited to the details given herein. Accordingly, while specific embodiments have been illustrated and described, numerous modifications come to mind without significantly departing from the scope of the invention as defined in the appended claims.

1. A method for presenting information associated to a user and for tracking viewing thereof, the method comprising:
receiving a plurality of textual information entries associated to a user;
receiving a video associated to the user,
for each of a plurality of viewing sessions associated to the user:
playing back, within a user interface, the video associated to the user;
displaying, within the user interface during the playing back, a plurality of interactive objects, at least one of the interactive objects being linked to a subset of the textual information entries associated to the user;
detecting during the playing back of the video one or more interactions within the user interface by a viewer of the session; and
in response to each detected interaction by the viewer, storing a log entry for the detected interaction, the log entry indicating a type of the interaction and a playback time of the video at the moment of the detected interaction.

2. The method of claim 1, wherein the detected interactions by the viewer comprise the viewer terminating viewing session prior to the playing back of the video reaching the end of the video; and
wherein the stored log entry indicates viewing session terminated as the type of the interaction; and
the method further comprises:
receiving a reporting request from the user for tracking duration of playing back of the video within the viewing sessions; and
in response to receiving the request:
determining one or more scores based on the playback time for interactions of the viewing session terminated type across the plurality of view sessions.

3. (canceled)

4. (canceled)

5. The method of claim 1, wherein the detected interactions by the viewer comprise the playing back of the video reaching the end of the video; and
wherein the stored log entry indicates video ended as the type of the interaction; and
the method further comprises:
receiving a reporting request from the user for tracking number of interactions of the video ended type; and
in response to receiving the request:
determining a score for interactions of the video ended type based on the number of interactions across the plurality of viewing sessions of the video ended type and a total number of viewing sessions.

6. (canceled)

7. (canceled)

8. The method of claim 1, wherein the video comprises captured images of a torso and head of the user and wherein the method further comprises:
detecting the torso and the head of the user as foreground objects within the video;
detecting areas other than the torso and the head of the user as background scene within the video;
removing the background scene from the video; and
inserting within the video a replacement background scene within areas of the video having the background scene removed;
wherein the video having the background scene removed and the replacement background scene inserted is played back during each of the plurality of viewing sessions; and
wherein the interactive objects are overlaid on the video during the playing back of the video and located within areas of the video having the background scene removed.

9. (canceled)

10. (canceled)

11. (canceled)

12. The method of claim 1, wherein the video comprises captured images of a head of the user and wherein the method further comprises:
determining a three-dimensional profile of the user's head;
generating a three-dimensional reconstruction of the user's head;
wherein playing back the video associated to the user comprises displaying, within the user interface, the three-dimensional reconstruction of the user's head;
wherein the three-dimensional reconstruction of the user's head is displayed within a virtual three-dimensional environment during the playing back of the video; and
wherein the interactive objects are interactive three-dimensional objects displayed within the virtual three-dimensional environment.

13. (canceled)

14. (canceled)

15. (canceled)

16. (canceled)

17. (canceled)

18. The method of claim 1, wherein the detected interactions by the viewer comprise one or more interactions with one of the displayed interactive objects and wherein the method further comprises:
in response to each detected interaction with one of the displayed interactive objects:
displaying the subset of textual information entries linked to the interactive object interacted with; and
wherein the log entry stored in response to each detected interaction with one of the displayed interactive objects indicates a type of interactive object interacted with as the type of the interaction.

19. (canceled)

20. The method of claim 18, wherein displaying the subset of textual information entries linked to the interactive object interacted with comprises:
displaying, within the user interface, the title of each of the textual information entries of the subset, each title being linked to a content of said textual information entry;
detecting a further user interaction with one of the displayed titles of the textual information entries;
in response to detecting the further user interaction:
displaying, within the user interface, the content linked to said one of the displayed titles of the textual information entries interacted with; and
storing a log entry indicating viewing of the content of the textual entry; and
wherein the stored log entry indicating viewing of the content of the textual entry is associated with the stored log entry for the detected interaction by the viewer during play back of the video.

21. (canceled)

22. The method of claim 18, wherein a first of the interactive objects is linked to a first subset of textual information entries of professional type;
wherein a second of the interactive objects is linked to a second subset of textual information entries of interests type;
wherein a third of the interactive objects is linked to a third subset of textual information entries of contact information type; and
wherein a fourth of the interactive objects is linked to information entries of portfolio type.

23. (canceled)

24. The method of claim 18, further comprising:
receiving a reporting request from the user;
in response to receiving the request:
grouping the stored log entries across the plurality of viewing sessions into a plurality of groups by the type of interaction;
determining a score for each group of type of interaction; and
displaying the determined score for each group of type of interaction.

25. (canceled)

26. A computer-implemented system comprising:
at least one data storage device; and
at least one processor operably coupled to the at least one storage device, the at least one processor being configured for:
receiving a plurality of textual information entries associated to a user;
receiving a video associated to the user,
for each of a plurality of viewing sessions associated to the user:
playing back, within a user interface, the video associated to the user;
displaying, within the user interface during the playing back, a plurality of interactive objects, at least one of the interactive objects being linked to a subset of the textual information entries associated to the user;
detecting during the playing back of the video one or more interactions within the user interface by a viewer of the session; and
in response to each detected interaction by the viewer, storing a log entry for the detected interaction, the log entry indicating a type of the interaction and a playback time of the video at the moment of the detected interaction.

27. The system of claim 26, wherein the detected interactions by the viewer comprise the viewer terminating viewing session prior to the playing back of the video reaching the end of the video; and
wherein the stored log entry indicates viewing session terminated as the type of the interaction; and
wherein the processor is further configured for:
receiving a reporting request from the user for tracking duration of playing back of the video within the viewing sessions; and
in response to receiving the request:
determining one or more scores based on the playback time for interactions of the viewing session terminated type across the plurality of view sessions.

28. (canceled)

29. (canceled)

30. The system of claim 26, wherein the detected interactions by the viewer comprise the playing back of the video reaching the end of the video; and
wherein the stored log entry indicates video ended as the type of the interaction; and
wherein the processor is further configured for:
receiving a reporting request from the user for tracking number of interactions of the video ended type; and
in response to receiving the request:
determining a score for interactions of the video ended type based on the number of interactions across the plurality of view sessions of the video ended type and a total number of viewing sessions.

31. (canceled)

32. (canceled)

33. The system of claim 26, wherein the video comprises captured images of a torso and head of the user and wherein the processor is further configured for:
detecting the torso and the head of the user as foreground objects within the video;
detecting areas other than the torso and the head of the user as background scene within the video; and
removing the background scene from the video; and
inserting within the video a replacement background scene within areas of the video having the background scene removed;
wherein the video having the background scene removed and the replacement background scene inserted is played back during each of the plurality of viewing sessions; and
wherein the interactive objects are overlaid on the video during the playing back of the video and located within areas of the video having the background scene removed.

34. (canceled)

35. (canceled)

36. (canceled)

37. The system of claim 26, wherein the video comprises captured images of a head of the user and wherein the processor is further configured for:
determining a three-dimensional profile of the user's head;
generating a three-dimensional reconstruction of the user's head; and
wherein playing back the video associated to the user comprises displaying, within the user interface, the three-dimensional reconstruction of the user's head;
wherein the three-dimensional reconstruction of the user's head is displayed within a virtual three-dimensional environment during the playing back of the video; and
wherein the interactive objects are overlaid on the video during the playing back of the video.

38. (canceled)

39. (canceled)

40. (canceled)

41. (canceled)

42. (canceled)

43. The system of claim 26, wherein the detected interactions by the viewer comprise one or more interactions with one of the displayed interactive objects and wherein the processor is further configured for:
in response to each detected interaction with one of the displayed interactive objects:
displaying the subset of textual information entries linked to the interactive object interacted with; and
wherein the log entry stored in response to each detected interaction with one of the displayed interactive objects indicates a type of interactive object interacted with as the type of the interaction.

44. (canceled)

45. The system of claim 43, wherein displaying the subset of textual information entries linked to the interactive object interacted with comprises:
displaying, within the user interface, the title of each of the textual information entries of the subset, each title being linked to a content of said textual information entry;
detecting a further user interaction with one of the displayed titles of the textual information entries;
in response to detecting the further user interaction:
displaying, within the user interface, the content linked to said one of the displayed titles of the textual information entries interacted with; and
storing a log entry indicating viewing of the content of the textual entry; and
wherein the stored log entry indicating viewing of the content of the textual entry is associated with the stored log entry for the detected interaction by the viewer during play back of the video.

46. (canceled)

47. The system of claim 43, wherein a first of the interactive objects is linked to a first subset of textual information entries of professional type;
wherein a second of the interactive objects is linked to a second subset of textual information entries of interests type;
wherein a third of the interactive objects is linked to a third subset of textual information entries of contact information type; and
wherein a fourth of the interactive objects is linked to information entries of portfolio type.

48. (canceled)

49. The system claim 43, wherein the processor is further configured for:
receiving a reporting request from the user;
in response to receiving the request:
grouping the stored log entries across the plurality of viewing sessions into a plurality of groups by the type of interaction;
determining a score for each group of type of interaction; and
displaying the determined score for each group of type of interaction.

50. (canceled)

51. (canceled)

52. A method for presenting information associated to a user, the method comprising:
receiving a plurality of textual information entries associated to a user;
receiving a video associated to the user and having captured images of a torso and head of the user;
detecting the torso and the head of the user as foreground objects within the video;
detecting areas other than the torso and the head of the user as background scene within the video;
removing the background scene from the video;
for each of a plurality of viewing sessions associated to the user:
playing back, within a user interface, the video associated to the user with the background scene removed;
displaying, within the user interface during the playing back, a plurality of interactive objects, at least one of the interactive objects being linked to a subset of the textual information entries associated to the user, the interactive objects being overlaid on the video during playing back of the video;
detecting during the playing back of the video one or more interactions with one of the displayed interactive objects; and
in response to each detected interaction with one of the displayed interactive objects, displaying the subset of textual information entries linked to the interactive object interacted with.

53. The method of claim 52, further comprising inserting within the video a replacement background scene within areas of the video having the background scene removed; and
wherein the video having the background scene removed and the replacement background scene inserted is played back during each of the plurality of viewing sessions; and
wherein the interactive objects are located within areas of the video having the background scene removed.

54. A computer-implemented system comprising:
at least one data storage device; and
at least one processor operably coupled to the at least one storage device, the at least one processor being configured for:
receiving a plurality of textual information entries associated to a user;
receiving a video associated to the user and having captured images of a torso and head of the user;
detecting the torso and the head of the user as foreground objects within the video;
detecting areas other than the torso and the head of the user as background scene within the video;
removing the background scene from the video;
for each of a plurality of viewing sessions associated to the user:
playing back, within a user interface, the video associated to the user with the background scene removed;
displaying, within the user interface during the playing back, a plurality of interactive objects, at least one of the interactive objects being linked to a subset of the textual information entries associated to the user, the interactive objects being overlaid on the video during playing back of the video;
detecting during the playing back of the video one or more interactions with one of the displayed interactive objects; and
in response to each detected interaction with one of the displayed interactive objects, displaying the subset of textual information entries linked to the interactive object interacted with.

55. The system of claim 54, wherein the processor is further configured for inserting within the video a replacement background scene within areas of the video having the background scene removed; and
wherein the video having the background scene removed and the replacement background scene inserted is played back during each of the plurality of viewing sessions; and
wherein the interactive objects are located within areas of the video having the background scene removed.
